(19) United States
(12) Patent Application Publication
(10) Pub. No.: US 2018/0104560 A1
(43) Pub. Date: Apr. 19, 2018

(54) Golf Training Aid Simulating a Grass Cutting Motion

(71) Applicant: Edward Currier, Palm Harbor, FL (US)

(72) Inventor: Edward Currier, Palm Harbor, FL (US)

(21) Appl. No.: 15/787,506

(22) Filed: Oct. 18, 2017

Related U.S. Application Data
(60) Provisional application No. 62/409,777, filed on Oct. 18, 2016.

(51) Int. Cl. A63B 69/36; G09B 19/00

(52) U.S. Cl. CPC A63B 69/36; A63B 69/3623; G09B 19/0038

(57) ABSTRACT

A golf training aid simulating a grass whip consists of a club shaft, a neck portion, and a blade portion. The blade portion is connected to the club shaft via the neck portion. The club shaft replicates the shaft of a golf club. The blade portion replicates the club head of the golf club. The weight for the blade portion is specifically selected so that the wrists of the user adjusts along with the swing. Moreover, the shape of the blade portion is specifically shaped to minimize air resistance. The shape of the blade portion also helps the blade portion to smoothly cut through grass. Since the apparatus helps the user practice on striking grass during a swing, when a golf club is used with a golf ball, the user can accurately strike the ball at an optimal contact point.

The current application claims a priority to the U.S. Provisional Patent application Ser. No. 62/409,777 filed on Oct. 18, 2016.

### FIELD OF THE INVENTION

The present invention relates generally to golf training aids. More specifically, the present invention is a golf swing training apparatus that utilizes a grass cutting motion. By utilizing the present invention, which is based upon natural body movements, the user can perfect a golf swing with greater efficiency.

### BACKGROUND OF THE INVENTION

Golf is a sport enjoyed by individuals of all ages. Regardless of the level in which the sport is played, golf requires a significant amount of training. A general training process for golf would be mainly based upon improving muscle movement, coordination, muscular endurance, and balance. A majority of the available golf training programs and golf training aids have significant drawbacks that need to be addressed.

One significant drawback of existing programs is the lack of attention given to beginners. The athletic ability varies from one person to another. Thus, the muscle movements and muscle coordination related to a certain activity can also vary from one person to another. Most training programs have minimum regard to the differences among individuals. In such situations, the many instructions related with a training program can be overwhelming to a beginner. Therefore, for greater results, a training program that utilizes natural body movements of the user is clearly needed. Another drawback is the lack of training aids that mimic the exact motion of a golf swing. As an example, golf training whips, that have a weighted end and a flexible body, are significantly different from a golf club. Thus, the user does not get the intended experience when training with these whips. Using grass whips is another successful training method. However, most of the grass whips are significantly different from a golf club. As an example, most of the grass whips are designed for one-handed operation. In other instances, the grass whips have a wooden grip which is significantly larger in diameter than a golf club. The differences in design significantly impacts the ability of mastering the golf swing.

The objective of the present invention is to address the aforementioned issues. More specifically, the present invention introduces a golf training aid that simulates a grass cutting motion. Compared to other available products, the present invention accurately mimics a golf club so that the golf swing can be accurately practiced via the grass cutting motion. Moreover, the grass cutting motion allows the user to master the golf swing with minimum guidance.

### BRIEF DESCRIPTION OF THE DRAWINGS

FIG. 1 is a perspective view of the present invention.

FIG. 2 is another perspective view of the present invention.

FIG. 3 is a side view of the present invention.

FIG. 4 is an exploded view of the present invention.

FIG. 5 is a perspective view of the blade portion.

### DETAIL DESCRIPTIONS OF THE INVENTION

All illustrations of the drawings are for the purpose of describing selected versions of the present invention and are not intended to limit the scope of the present invention.

The present invention is a golf training aid that helps a user practice and master a golf swing. More specifically, the present invention helps the user develop skills such as muscle movement, balance, and coordination which are essential to execute a proper golf swing. In doing so, the present invention is designed to simulate a grass whip motion so that the user can develop the required skills through natural body movements.

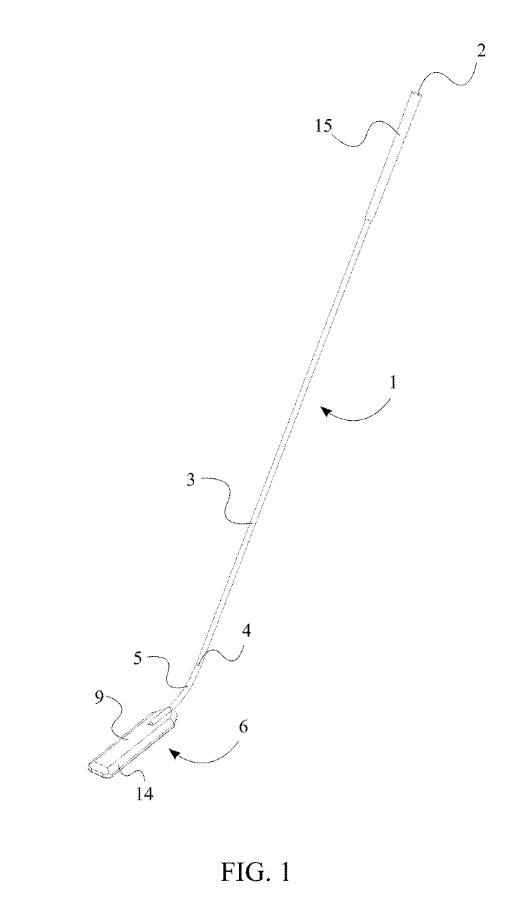

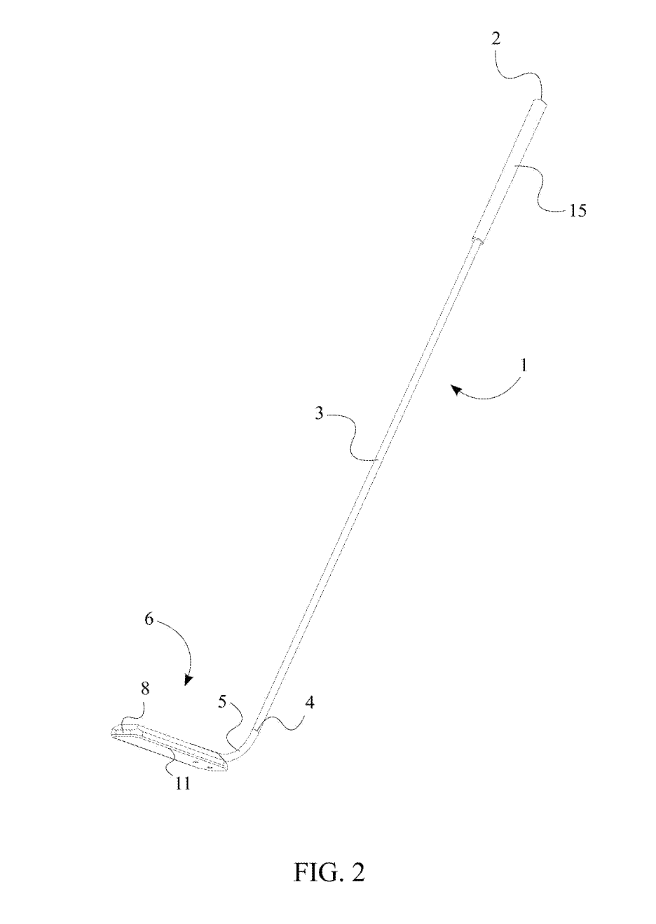

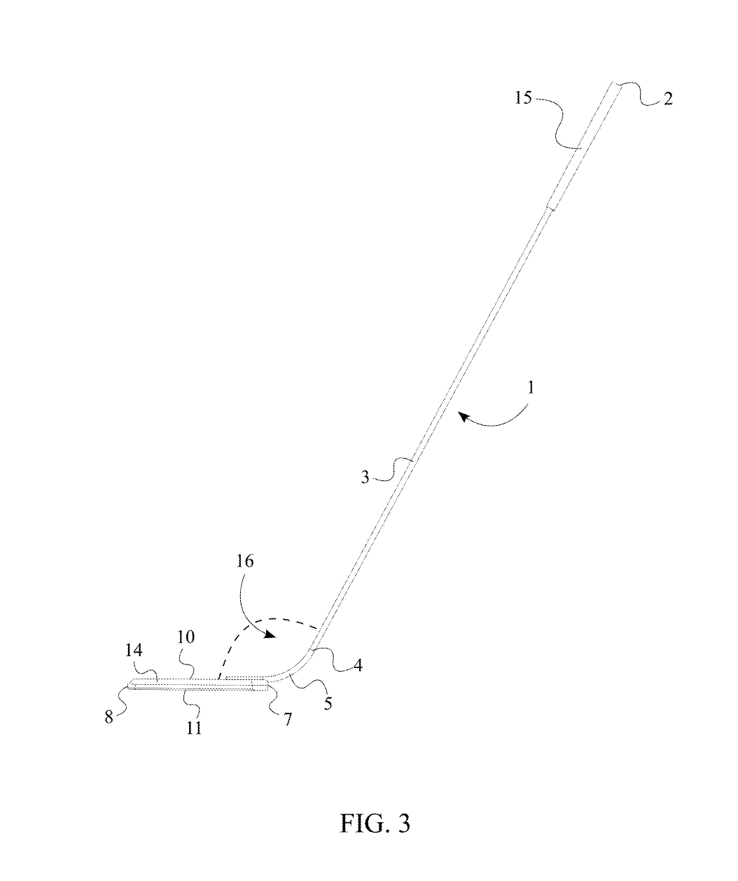

As illustrated in FIG. 1 and FIG. 2, to mimic the use of a golf club and allow the user to practice a swing used in golf, the present invention comprises a club shaft 1, a neck portion 5, and a blade portion 6. The club shaft 1, which is preferably made of graphite or other comparable material, is similar to a shaft of a golf club and comprises a first end 2, a club shaft body 3, and a second end 4. The club shaft body 3, which determines the overall length of the club shaft, extends from the first end 2 to the second end 4. The length of the club shaft body 3 can vary in different embodiments of the present invention. As an example, the club shaft body 3 can be short to cater children utilizing the present invention. On the other hand, the club shaft body 3 can be long to cater adults who intend on utilizing the present invention. The neck portion 5 functions as a connecter between the club shaft 1 and the blade portion 6 so that the blade portion 6 can be positioned at a preferred lie angle, which is an angle between the club shaft 1 and a ground line. To do so, the neck portion 5 is terminally connected at the second end 4. On the other hand, the blade portion 6 is connected to the neck portion 5 opposite the club shaft 1. As shown in FIG. 3, in the final configuration, the blade portion 6 is oriented at an obtuse angle 16 from the club shaft 1 so that the preferred lie angle is achieved. The blade portion 6 represents a club head of a golf club. In general, the club head is designed such that the weight of the golf club is concentrated towards the club head. To be similar to the club head in terms of weight distribution, the blade portion 6 is specifically weighted so that the overall weight of the present invention is concentrated at the blade portion 6. In the preferred embodiment, the present invention has a weight similar to a 5-iron club. The weight of the present invention is especially important to practice the wrist movements that occur during a golf swing. In other words, the weight of the blade portion 6 forces the wrists of the user to mimic a position of the wrists during a golf swing.

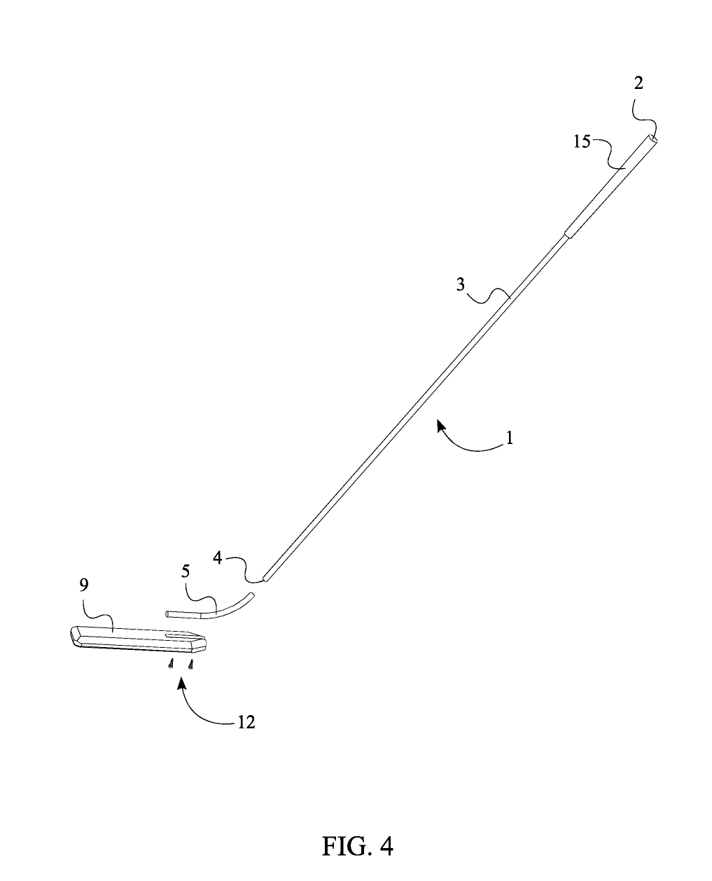

As shown in FIG. 4, the present invention further comprises an attachment mechanism 12 to connect the neck portion 5 to the blade portion 6. The attachment mechanism 12 can vary in different embodiments of the present invention. As an example, in one embodiment of the present invention the neck portion 5 can be welded to the blade portion 6. However, in the preferred embodiment of the present invention, the neck portion 5 is connected to the blade portion 6 via a plurality of screws.

As discussed earlier, the blade portion 6, which represents the club head, is vital in simulating a golf swing. Moreover, the shape of the blade portion 6 is important so that the present invention has aerodynamic features when the grass cutting motion is executed. To achieve the required shape, the blade portion 6 comprises a proximal end 7, a distal end 8, a blade body 9, a top edge 10, and a bottom edge 11. The blade body 9, which has an overall rectangular shape, extends from the proximal end 7 to the distal end 8. A distance between the proximal end 7 and the distal end 8 determines the length of the blade body 9. Moreover, the blade body 9 extends from the top edge 10 to the bottom edge 11 so that a thickness of the blade body 9 is determined by a distance between the top edge 10 and the bottom edge 11. When considering the connection between the neck portion 5 and the blade portion 6, the proximal end 7 is connected adjacent to the neck portion 5 opposite the second end 4 of the club shaft 1. As mentioned before, the neck portion 5 can be welded or connected via the plurality of screws.

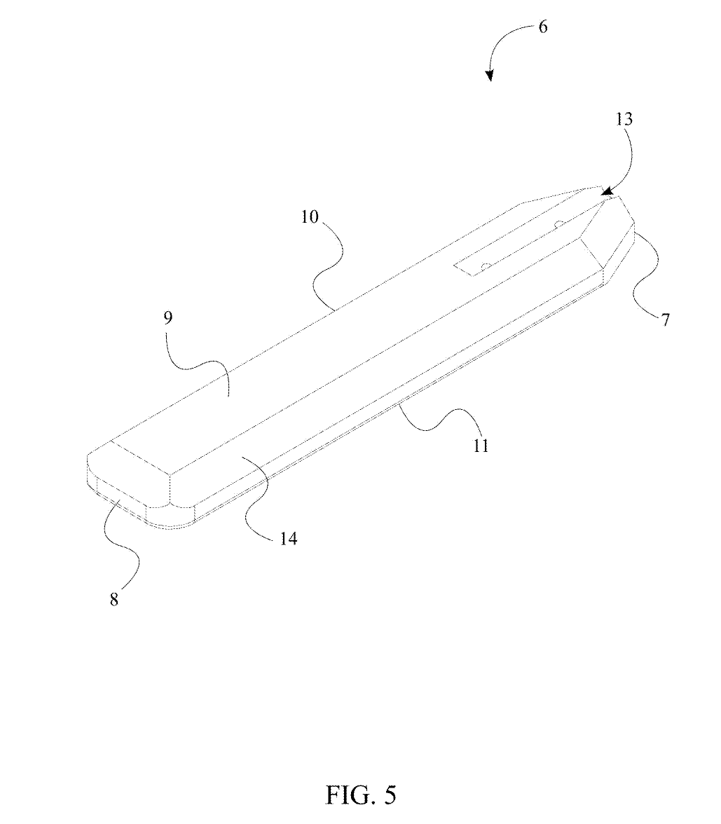

As illustrated in FIG. 5, the present invention further comprises a receiving channel 13 that is used to position the neck portion 5 appropriately. The receiving channel 13 traverses into the blade body 9 at the proximal end 7 adjacent to the top edge 10 so that the neck portion 5 can be positioned into the receiving channel 13. Preferably, a diameter of the receiving channel 13 is equal to or marginally larger than a diameter of the neck portion 5 so that the neck portion 5 is firmly positioned within the receiving channel 13.

As discussed before, the present invention utilizes the grass cutting motion for practicing the golf swing. In particular, the present invention helps the user focus on striking the grass with the blade portion 6 so that when a golf club is used, the club head would meet the golf ball at an optimal contact point. Since the blade portion 6 strikes the grass during each swing, the blade portion 6 needs to be designed appropriately to traverse through grass. To do so, the present invention further comprises a beveled cut edge 14 that is perimetrically distributed along the top edge 10. The beveled cut edge 14 also helps the blade portion 6 move through air with minimum resistance. On the other hand, the flat surface along the bottom edge 11 of the blade body 9 allows the blade portion 6 to smoothly strike a surface.

The present invention further comprises a gripping portion 15 that allows the user to maintain a firm hold on the present invention. The gripping portion 15, which is similar to a grip on a golf club, is preferably made of rubber or other comparable material. Moreover, the gripping portion 15 is positioned along the club shaft body 3 adjacent to the first end 2. The gripping portion 15 is sufficiently sized so that the user can hold the present invention at a preferred location.

When utilizing the present invention, the following process flow is generally followed. Initially, the user holds the present invention at the gripping portion 15. More specifically, a grip used when holding a golf club is used to hold the present invention at the gripping portion 15. The design of the blade portion 6 allows both left-handed users and right-handed users utilize the present invention in the same manner. When appropriately gripped, the user simulates a grass cutting motion with the present invention. In doing so, the user focuses on cutting the grass with the blade portion 6 such that the blade body 9 along the bottom edge 11 strikes the ground during each swing. Since the present invention trains the user to focus on cutting the grass during the swing, when a golf club is used with a golf ball, the user maintains focus on the grass beneath the golf ball. Thus, the clubhead of the gold club meets the golf ball at the optimal contact point. Moreover, the back and forth swinging of the present invention ensures that the user utilizes all muscles that are involved in a golf swing. In other words, the present invention helps the user practice the full range of motion related to a golf swing. In addition to training the muscles involved in a golf swing, the properties of the blade portion 6 ensure that the wrists of the user are correctly positioned during each swing. The continuous use of the present invention also helps improve club head speed. By utilizing the present invention, the user is provided with a simple but highly effective golf training aid.

Although the invention has been explained in relation to its preferred embodiment, it is to be understood that many other possible modifications and variations can be made without departing from the spirit and scope of the invention as hereinafter claimed.

What is claimed is:

1. A golf training aid with simulating a grass cutting motion comprises:
a club shaft;
a neck portion;
a blade portion;
the club shaft comprises a first end, a club shaft body, and a second end;
the club shaft body extending from the first end to the second end;
the neck portion being terminally connected at the second end; and
the blade portion being connected to the neck portion opposite to the club shaft.

2. The golf training aid simulating a grass cutting motion as claimed in claim 1, wherein the blade portion is oriented at an obtuse angle from the club shaft.

3. The golf training aid simulating a grass cutting motion as claimed in claim 1 further comprises:
an attachment mechanism; and
the neck portion being connected to the blade portion via the attachment mechanism.

4. The golf training aid simulating a grass cutting motion as claimed in claim 1 further comprises:
the blade portion comprises a proximal end, a distal end, a blade body, a top edge, and a bottom edge;
the blade body extending from the proximal end to the distal end;
the top edge and the bottom edge being positioned in between the proximal end and the distal end;
the blade body extending from the top edge to the bottom edge; and
the proximal end being connected adjacent to the neck portion opposite the second end of the club shaft.

5. The golf training aid simulating a grass cutting motion as claimed in claim 4, wherein the blade body is rectangular in shape.

6. The golf training aid simulating a grass cutting motion as claimed in claim 4 further comprises:
a receiving channel;
the receiving channel traversing into the blade body at the proximal end adjacent to the top edge; and
the neck portion positioned into the receiving channel.

7. The golf training aid simulating a grass cutting motion as claimed in claim 1 further comprises:
a beveled cut edge; and
the beveled cut edge being perimetrically distributed along a top edge of the blade portion.

8. The golf training aid simulating a grass cutting motion as claimed in claim 1 further comprises:
a gripping portion; and
the gripping portion being positioned along the shaft body adjacent to the first end.
